(19) United States
(12) Patent Application Publication
(10) Pub. No.: US 2011/0097677 A1
(43) Pub. Date: Apr. 28, 2011

(54) System for decontaminating marine life infestations from marine vessels

(76) Inventor: Karl V. Ryan, Los Gatos, CA (US)

(21) Appl. No.: 12/589,700

(22) Filed: Oct. 27, 2009

(51) Int. Cl. F27B 17/00; B08B 5/04

(52) U.S. Cl. 432/1; 134/21; 134/123; 432/36

(57) ABSTRACT

A marine life decontamination system embodiment of the present invention comprises a drive-in chamber large enough to accommodate a boat on its trailer and even the two vehicle too. Once inside the chamber, eaters are used to bring the boat and trailer temperatures up to 112° F. to 165° F. for a minimum soak-in time, with five minutes being sufficient in most cases. Humidity measurements of the off-gassing water vapors are used to sense when all the available water that could harbor marine life has been removed. Such combination of high temperatures and no available water assures that pests cannot survive to contaminate a new body of water.

### BACKGROUND OF THE INVENTION

1. Field of the Invention

The present invention relates to marine life infestation controls, and more particularly to decontamination systems to neutralize infestations of zebra mussels and other highly invasive pests in boats and other vessels.

2. Description of Related Art

Highly invasive marine species like Quagga Mussels, New Zealand Mud Snails, and Zebra Mussels are spreading throughout North America and causing widespread destruction of natural habitats and man-made equipment. Once a body of water is infested, there seems to be no effective treatment that will eradicate the pests. Keeping a body of water like Lake Tahoe free of these pests therefore falls on not allowing any contamination to occur the first time. And the infestations are getting closer, nearby Lake Mead has a serious infestation of Quagga Mussels.

Boats and ships that move from one body of water to another are alleged to be the means that carry and spread the major infestations of marine pests in North American. Infested ballast water aboard one ship from Europe is suspected of having dumped that ballast water in the Great Lakes. Smaller boats that intake water as a coolant for their engines have also been responsible for spreading Zebra Mussels to the unconnected lakes and streams they visit by trailer.

So, the Lake Tahoe authorities, and others, are now beginning to quarantine their waters from boats that have been outside their watershed areas. Those that do allow outsiders to come in are requiring the use of wash downs, chemical biocides, and inspection, before allowing the boat and trailer in.

Conventional decontamination methods are described by John Brockhurst in U.S. Pat. No. 5,148,777, issued Sep. 22, 1992; and by David Clum, et al., in U.S. Pat. No. 5,389,266, issued Feb. 14, 1995. These methods, and others, have not proven very effective nor very affordable when applied to the decontamination of boats being hauled on trailers behind tow vehicles.

What is needed is a drive-through chamber that can quickly and easily accommodate entire boats being hauled on trailers behind tow vehicles, and that can do the job of decontamination quickly and without damaging the equipment.

### SUMMARY OF THE INVENTION

Briefly, a marine life decontamination system embodiment of the present invention comprises a drive-in chamber large enough to accommodate a boat on its trailer and even the tow vehicle too. Once inside the chamber, heaters are used to bring the boat and trailer temperatures up to 112° F. to 165° F. for a minimum soak-in time of at least one minute, with five minutes being sufficient in most cases. Humidity measurements of the off-gassing water vapors are used to sense when all the available water that could harbor marine life has been removed. Such combination of high temperatures and no available water assures that pests cannot survive to contaminate a new body of water.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of a decontamination system embodiment of the present invention;

FIG. 2A is a perspective view diagram of the outside of a decontamination booth embodiment of the present invention;

FIG. 2B is a cutaway view diagram of the side of the decontamination booth of FIG. 2A;

FIG. 2C is a side view diagram of the decontamination booth of FIG. 2A;

FIG. 2D is a top view diagram of the decontamination booth of FIG. 2A; and

FIG. 2E is an end view diagram of the decontamination booth of FIG. 2A.

### DETAILED DESCRIPTION OF THE INVENTION

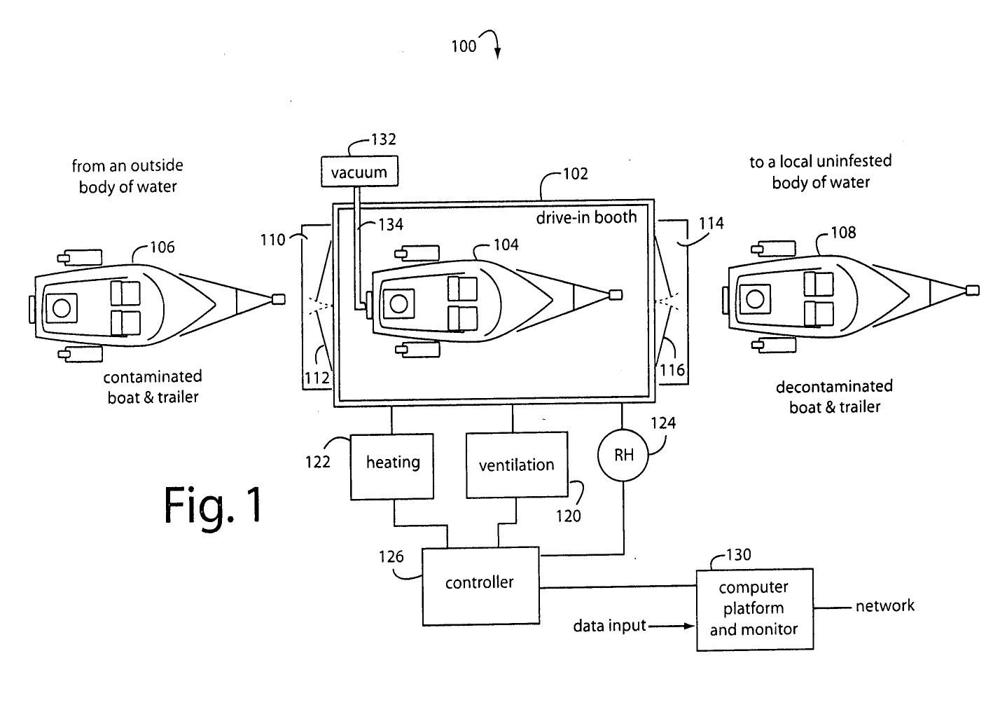

FIG. 1 represents a decontamination system embodiment of the present invention, and is referred to herein by the general reference numeral 100. A typical decontamination system 100 includes a drive-in chamber 102 that is large enough to accommodate and enclose a marine vessel 104 for heat soaking. Typical marine vessels 104 that could be processed this way are boats, kayaks, canoes, wakeboards, skis, gear, rafts, and submersibles that can be hauled-out on trailers and transported by a tow vehicle. It would be advantageous to place decontamination system 100 near a boat launch to a protected lake or river, and to size it to accommodate both the trailers and towing vehicles too. Stickers could be issued to identify treated vessels.

A drive-through construction for drive-in chamber 102 would allow queues of boats 106 and 108 to file through efficiently and quickly. An entry ramp 110 and entry door 112 allow a next boat 106 to enter, and an exit ramp 114 and exit door 116 allow a treated boat 108 to proceed on down to the protected body of water. Such doors should be air-tight to best hold in the heated air.

A ventilation system 120 is connected to circulate and evacuate the air from the interior of the drive-in chamber 102. A heating system 122 is connected to heat the interior air of the drive-in chamber. The ventilation system 120 is connected to circulate air and evacuate water and moisture from items placed inside the drive-in chamber. A relative humidity (RH) measurement system 124 is connected to measure the relative humidity of being air exhausted from the drive-in chamber 102 through the ventilation system 120. A controller 126 is programmed to manage the heating and ventilation of the interior of the drive-in chamber, e.g., according to measurements of the relative humidity and temperature. The heating system 122 is configured to be able to raise the temperatures of marine vessel 104, and to reduce the relative humidity internal to the drive-in chamber 102 to levels that can decontaminate marine vessel 104 of marine life. In general, the heat-soaking temperatures are best evened out by circulating the heated air inside. These should be able to reach at least 112° F. for a time and measured relative humidity calculated to kill particular marine life on the marine vessel. Alternatively, at least 135° F. for a time sufficient to bake out any remaining water. These temperatures are reported in the Literature to be lethal to Zebra Mussels. See, Zebra Mussel Research Technical Notes, US Army Corps of Engineers, Waterways Experiment Station, Section 2-Control Methods, Technical Note ZMR-2-20, September 1998.

Unhitching and hitching back a boat on a trailer so they can be treated inside chamber 102 would be inconvenient and inefficient, especially if there was a queue of users wanting access to a boat launch. So, it would be advantageous to size the drive-in chamber 102 to be large enough to accommodate and enclose not only a boat and trailer, but also their tow vehicle as well. That way, unhitching and hitching back of the boat and trailer would be unnecessary.

The evaporation of water of water inside chamber 102 and inside marine vessel 104 can be quickened by siphoning, draining, or otherwise drawing out any liquid water that may be pooled inside. Water could therefore be removed more quickly and at lower heating temperatures if a vacuuming system 132 was used to remove excess water. Such would include an attachment 134 to connect to the water inlets and outlets of marine vessel 104. The vacuuming system 132 provides for a more rapid evacuation of residual water from inside the drive-in chamber 102.

In a still further embodiment of the present invention, controller 126 is programmed to cause the interior of the drive-in chamber 102 to be heated to at least 112° F. for at least one minute, with five minutes being sufficient in most cases. The heating system 122 would correspondingly have to be sized to accomplish this goal. Present estimates are that conventional tow vehicles, boats, and trailers could tolerate these temperatures without being damaged. Such temperatures would certainly destroy any marine life clinging on or secreted inside.

A computer platform and monitor 130 is used to log-in and report boat inspections, treatments, maintenance, operator data, and certifications. As such, it is very similar to the Department of Motor Vehicle (DMV) smog certification systems in use in California by licensed technicians. In particular, computer platform and monitor 130 securely records log-in times, log-out times, boat tag numbers, relative humidity and temperature readings inside the chamber, decontamination operator identification, name and address of the boat owner, fees charged, etc.

A method embodiment of the present invention for decontaminating a marine vessel comprises vacuum pumping the internal workings of a marine vessel and its exterior that come into contact with water during operation to remove excess water. Then, heating the marine vessel inside a chamber to elevate its temperature to at least 135° F. for a time sufficient to evaporate any water remaining after the step of vacuum pumping. Air can be forced through the chamber to increase and improve the heat transfer to the marine vessel and to yield a constant temperature throughout. A preliminary step of removing excess water from the marine vessel by opening up any of its drain plugs and stoppers would be helpful.

The relative humidity of air inside the chamber is measured. A bottoming out of the relative humidity can be interpreted as an indication that just about all residual water has been removed.

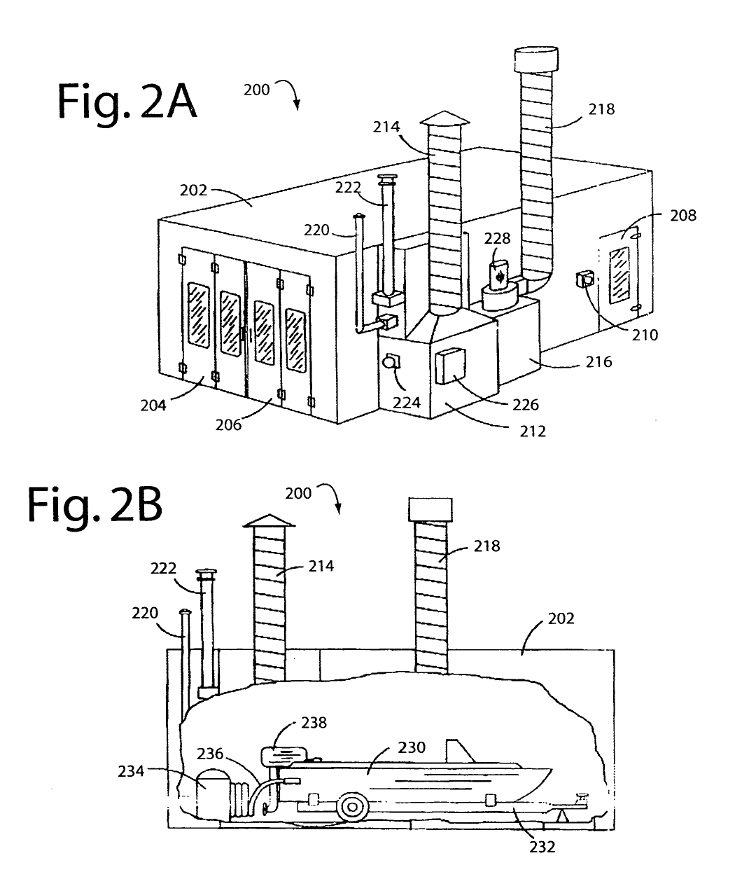

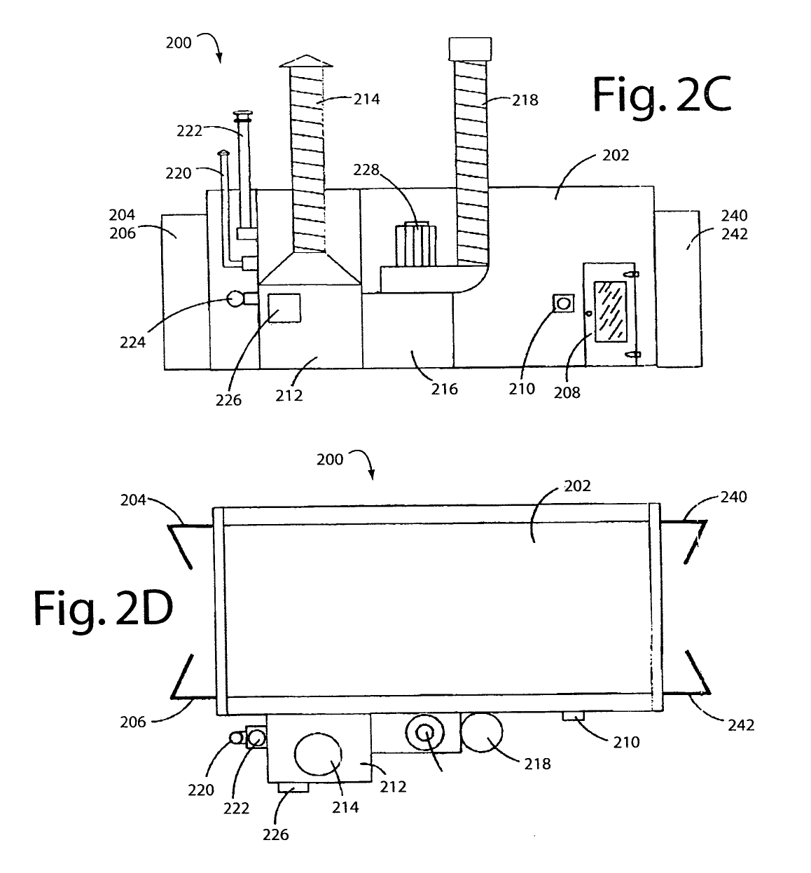

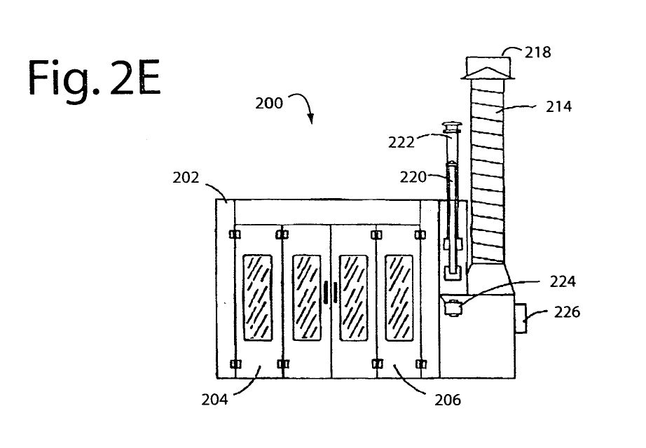

FIGS. 2A-2E represent a decontamination booth embodiment of the present invention, and is referred to herein by the general reference numeral 200. Decontamination booth 200 includes a building enclosure 202 fitted with front entry doors 204 and 206. Side entry man-door 208 allows workers to access the vessel. A relative humidity (RH) gauge 210 provides a visual indication of the RH inside. A heater 212 is connected to a ventilation air input duct 214, an air plenum 216, and a ventilation air exhaust duct 218. A combustion gas input stack 220 and exhaust stack 222 sit atop the heater. An external gas supply port 224 provides propane or natural gas to be burned inside the heater 212. A control panel 226 provides automatic management of the heating and ventilation systems. A ventilation fan motor 228 sits on top of air plenum 216.

In FIG. 2B can be seen a boat 230 on a trailer 232 inside the building enclosure 202. A vacuum pump system 234 with a hose 236 is connected to a boat motor 238 to drain it of water that could be contaminated. Rear exit doors 240 and 242 can also be seen in FIGS. 2C and 2D.

A typical heating system would use either propane or natural gas. A one million BTU heater many be necessary for the chamber sizes and temperatures contemplated herein. A small jet engine could be an economical way to generate the quick heat and air flow volumes required. Air flow volumes can exceed 100 cubic feet per minute. There also many not be any utility power available at a typical installation site, so including a generator would be necessary in many applications.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A decontamination system, comprising:
a drive-in chamber large enough to accommodate and enclose a marine vessel;
a ventilation system connected to circulate air and evacuate water and moisture from items placed inside the drive-in chamber;
a heating system connected to heat the interior air of the drive-in chamber; and
a controller to manage the heating and ventilation of the interior of the drive-in chamber;
wherein, the heating system is configured to be able to raise the temperatures of said marine vessel, and to reduce the relative humidity internal to the drive-in chamber to levels that can decontaminate said marine vessel of marine life.

2. The system of claim 1, further comprising:
a relative humidity measurement system connected to measure the relative humidity of air exhausted from the drive-in chamber through the ventilation system.

3. The system of claim 2, wherein:
the controller manages the heating and ventilation of the interior of the drive-in chamber according to a measurement provided by the relative humidity measurement system.

4. The system of claim 1, wherein:
the drive-in chamber is large enough to accommodate and enclose a boat, trailer, and tow vehicle.

5. The system of claim 4, further comprising:
a ramp into the drive-in chamber to facilitate the entry and exit of said boat and its trailer.

6. The system of claim 1, further comprising:
a set of doors in the drive-in chamber to facilitate the entry and exit of said marine vessel.

7. The system of claim 1, further comprising:
a vacuum pump system for attachment to a marine vessel and providing for a more rapid evacuation of residual water and water vapor.

8. The system of claim 1, wherein:
the controller is programmed to cause the interior of the drive-in chamber to be heated to at least 112° F. for at least one minute.

9. The system of claim 1, wherein:
the controller is programmed to cause the interior of the drive-in chamber to be heated to at least 112° F. for a time and measured relative humidity calculated to kill particular marine life that may be attached to items placed inside the drive-in chamber.

10. A method for decontaminating a marine vessel, comprising:
vacuuming the internal workings of a marine vessel and its exterior that come into contact with water during operation; and
heating said marine vessel inside a chamber to elevate its temperature to at least 135° F. for a time sufficient to evaporate any water remaining after the step of vacuuming.

11. The method of claim 10, further comprising:
forcing air through said chamber to increase and improve the heat transfer to the marine vessel and to yield a constant temperature throughout.

12. The method of claim 10, further comprising:
a preliminary step of removing excess water from said marine vessel by opening up any of its drain plugs and stoppers.

13. The method of claim 10, further comprising:
measuring the relative humidity of air inside said chamber and interpreting a bottoming out of the relative humidity as an indication that all residual water has been removed.
